(19) United States
(12) Patent Application Publication
(10) Pub. No.: US 2007/0123433 A1
(43) Pub. Date: May 31, 2007

(54) Treatment fluids and methods using zeolite and a delayed release acid for treating a subterranean formation

(75) Inventors: Diptabhas Sarkar, Houston, TX (US); Ian D. Robb, Duncan, OK (US); Bradley L. Todd, Duncan, OK (US)

Correspondence Address: Hilliburton Energy Services, Inc., 2600 S. 2nd Street, Duncan, OK, 73536-0440, US

(73) Assignee: Halliburton Energy Services, Inc.

(21) Appl. No.: 11/290,083

(22) Filed: Nov. 30, 2005

(51) Int. Cl. C09K 8/00; E21B 43/00

(52) U.S. Cl. 507/213; 507/219; 507/269

(57) ABSTRACT

The invention provides a treatment fluid for treating a subterranean formation penetrated by a wellbore, the treatment fluid comprising: (i) an aqueous carrier fluid; (ii) a zeolite; (iii) a polymeric gelling material; and (iv) a delayed release acid. The invention also provides a method for treating a subterranean formation penetrated by a wellbore, the method comprising the steps of pumping a treatment fluid comprising: (i) an aqueous carrier fluid; (ii) a zeolite; (iii) a polymeric gelling material; and (iv) a delayed release acid; and introducing the treatment fluid into the wellbore.

### CROSS-REFERENCE TO RELATED APPLICATIONS

### STATEMENT REGARDING FEDERALLY SPONSORED RESEARCH OR DEVELOPMENT

Not applicable

### REFERENCE TO MICROFICHE APPENDIX

Not applicable

### FIELD OF THE INVENTION

This invention generally relates to recovering hydrocarbons from a subterranean formation. More specifically, the invention relates to methods for treating a subterranean formation with a fluid containing zeolite and delayed release acid.

### BACKGROUND OF THE INVENTION

Hydrocarbon (e.g., oil and natural gas) in a subterranean formation can be reached by drilling a well into the subterranean formation.

After drilling the openhole, the next step is to complete the wellbore. As part of the well completion, a metal casing is normally positioned and cemented into place in the openhole to protect the openhole from fluids and pressures and to stabilize the wellbore. Where the casing spans a hydrocarbon-bearing reservoir of a subterranean formation, the casing is perforated to allow communication between the formation and wellbore. The casing also enables subsequent or remedial isolation of production zones adjacent to the wellbore by packers, plugs, or treatments.

After a well has been completed and placed onto production, from time to time it is helpful to workover a well by performing major maintenance or remedial treatments. Workover includes the repair or stimulation of a well to help restore, prolong, or enhance the production of hydrocarbons.

A treatment fluid can serve a wide range of purposes. As used herein, a treatment fluid is any fluid useful for preparing a well for production, including stimulation, isolation, or control of reservoir gas or water, drilling, drill-in, gravel packing, workover, among others. As used herein, a treatment fluid can include a drilling fluid or a workover or servicing fluid.

Some treatment fluids, such as fracturing fluids, may leak-off from the fracture into the formation during and after the fracturing process. Fluid loss is a term often used for the flow of fracturing fluid into the formation from the fracture. (The terms “fluid loss” and “leak-off” are used interchangeably herein). Fluid loss control is a term often used to indicate measures used to govern the rate and extent of fluid loss. The consequence of high fluid loss (also referred to as low fluid efficiency, where fluid efficiency is inversely related to the fluid loss into the formation) is that it is necessary to inject larger volumes of a fracturing fluid in order to create the designed fracture geometry, i.e., fracture length and width sufficient to hold all the injected proppant. Use of low efficiency fluids can increase the time and expense required to perform the fracturing operation.

To overcome the tendency of high fluid loss in fracturing fluids and gravel carrier fluids under some conditions, various fluid loss control additives (FLAs) have been tried. Silica, mica, and calcite, alone, in combination, or in combination with starch or crosslinked polymers are known to reduce fluid loss in polymer-based fracturing fluids, by forming a filter cake, on the formation face, which is relatively impermeable to water or by plugging pore throats (sometimes referred to “internal filter cake). Collectively, external filter cake and internal filter cake can by referred to as filter cake. After the drilling, completion, or servicing operation has been completed, the filter cake should be completely removed prior to placing the formation into production.

A filter cake formed with fluid loss control additives improves filter cake build up, and thus provides for improved fluid loss control in the subterranean formation. For example, silica improves filter cake build up and fluid loss control. However, filter cake formed of silica is difficult to remove after being formed, causing blockage of pores and giving significant reduction of permeability regain. One substitute for silica is calcite, which serves the same function of silica, but unlike silica, calcite advantageously dissolves with acidic solution. The acidic solution is allowed to remain in contact with the filter cake for a period of time sufficient to dissolve the filter cake or pore blockage.

Although filter cake formed of fluid loss additives such as calcite are effectively removed with acid, a significant amount of acid is needed to remove the filter cake. The more acid that is used to remove filter cake, the more corrosion is caused to metallic surfaces and completion equipment such as sand screens, which can cause their early failure. Further, weighting of the acid to keep it in contact with the sealing composition and keep from being displaced by heavier treatment fluids can result in separation of certain acid additive components, such as corrosion inhibitor, non-emulsifier, anti-sludging agents, etc. Still further, acid can also cause damage to the hydrocarbon bearing subterranean formation because it is sometimes incompatible with the producing formation. For example, the use of acid as a breaker can cause disintegration and dissolution of carbonate minerals and certain clay minerals such as zeolite and chlorite in the subterranean formation. Also, the acid can cause sludging of the formation's crude oil.

Thus, there are long-felt and continuing needs for improved methods for treating a subterranean formation to reduce fluid loss by using fluid loss control additives that provide easier removal of filter cake.

### SUMMARY OF THE INVENTION

The invention provides a treatment fluid for treating a subterranean formation penetrated by a wellbore, the treatment fluid comprising: (i) an aqueous carrier fluid; (ii) a zeolite; (iii) a polymeric gelling material; and (iv) a delayed release acid.

The invention also provides a method for treating a subterranean formation penetrated by a wellbore, the method comprising the steps of: pumping a treatment fluid into the subterranean formation through the wellbore comprising: (i) an aqueous carrier fluid; (ii) a zeolite; (iii) a polymeric gelling material; and (iv) a delayed release acid; and introducing the treatment fluid into the wellbore.

While the invention is susceptible to various modifications and alternative forms, specific embodiments thereof will be described in detail and shown by way of example. It should be understood, however, that it is not intended to limit the invention to the particular forms disclosed, but, on the contrary, the invention is to cover all modifications and alternatives falling within the spirit and scope of the invention as expressed in the appended claims.

### DETAILED DESCRIPTION OF THE PREFERRED EMBODIMENTS

The invention provides a treatment fluid for treating a subterranean formation penetrated by a wellbore. The treatment fluid comprises an aqueous carrier fluid; a zeolite; a polymeric gelling material; and a delayed release acid. The treatment fluid of the invention can form a filter cake comprising zeolite as a fluid loss control additives to prevent fluid loss in well treatments.

The carrier fluid provides a medium for the transport of other components of the treatment fluid into the formation. Preferably, the carrier fluid is an aqueous fluid such as water or brine. The aqueous fluid can be used to suspend zeolite. The carrier fluid can contain salts such as sodium chloride, potassium chloride, calcium chloride, a bromide, such as sodium bromide, ammonium chloride, tetramethylammonium chloride, zinc chloride, zinc bromide, and any mixtures adapted for the purposes of weighting the fluid or inhibiting the swelling of clays that may be found in the subterranean formation.

Any zeolite that is soluble in acid can be used in the invention. The zeolite can be a natural zeolite, a synthetic zeolite, or any mixture thereof in any proportion. Synthetic zeolites are preferred, however, as they clean up better than natural zeolites. Some natural zeolites include gmelinite, chabazite, dachiardite, clinoptilolite, faujasite, heulandite, levynite, erionite, cancrinite, scolecite, offretite, mordenite, and ferrierite. Some synthetic zeolites are zeolites X, Y, L, ZK-4, ZK-5, E, H, J, M, Q, T, Z, alpha and beta, ZSM-types and omega. The zeolite preferably has a unit cell size or pore size of about 4 Angstroms.

An advantage of the treatment fluid comprising zeolite as a fluid loss additive is that it can form filter cake or block pore throats and requires only about two thirds (⅔) the acid to dissolve than an equivalent calcite system. The granular size of zeolite 4 A particles (5 microns) is the same as that of BARACARB 5 (calcium carbonate with a median diameter of 5 microns and available from Halliburton Energy Services), and the fluid loss control capabilities are almost identical. Further, because zeolite has a lower specific gravity than calcite, the zeolites are lighter, and hence, easier to pump into the wellbore.

The quantity of zeolite in the treatment fluid can be an amount that is sufficient to achieve a desired fluid loss control level for the particular application based on the porosity and permeability of the formation. In the case of a treatment fluid adapted for fluid loss control, the quantity will depend, to some extent, upon the permeability of the formation and formation temperature. The quantity of zeolite in the treatment fluid will also depend on other factors, such as the desired level of fluid loss control. The quantity of zeolite is preferably included in the treatment fluid in the range of from about 0.5% to about 20% by weight of the composition.

The polymeric gelling material can be any polymeric material that is capable of forming a gel. For example, the polymeric gelling material can comprise, starch, polymer and crosslinker systems, etc. The polymer that is useful in polymer and crosslinker systems can be selected from the group consisting of: guar; gaur derivatives; cellulose derivatives; xanthan; and any mixtures thereof in any proportion. A preferred cellulose derivative useful in polymer and crosslinker systems is hydroxyethylcellulose. A preferred guar derivative useful in polymer and crosslinker systems is hydroxypropyl guar.

The delayed release acid for use in the invention can be any acid derivative that is capable of providing a delayed release of acid in the treatment fluid. The delayed release acid eventually provides a release of acid to disassemble the filter cake, whereby the filter cake substantially breaks. The delayed release acid is preferably selected such that the release of the acid is sufficiently delayed to allow the treatment fluid to be injected through the wellbore and into the formation. In some applications where a filter cake is desired to be formed, the delayed release acid is selected such that the release of the acid is sufficiently delayed to allow the treatment fluid to be injected through the wellbore, form a filter cake, and prevent fluid loss of subsequent treatment fluids that are injected into the wellbore.

Examples of delayed release acid for use in the invention include, but are not limited to esters; polyesters; anhydrides; polyanhydrides; lactides; polylactides; lactones; polylactones; orthoesters; polyorthoesters; or any mixtures in any proportion thereof. Of the foregoing acid derivatives, polylactides such as poly(lactic acid) is the most preferred delayed release acid. Most preferably, poly(lactic acid) is included in the treatment fluid in an amount that depends on the amount of zeolite used. Preferably, the amount of poly(lactic acid) is present in the amount of 1.2 times more than the amount of zeolite used in the treatment fluid.

In one embodiment, the delayed release of the acid is accomplished by encapsulating an acid with a material that allows for delayed release of the acid after wearing of the capsule. In this embodiment, any acid can be used in the invention which is capable of being encapsulated by the capsule and, upon wearing or breakage of the capsule, provide a decrease in the pH of the treatment fluid. For example, the capsule can comprise an enclosure member that is sufficiently permeable to at least one fluid existing in the formation or in the treatment fluid; such that the enclosure member is capable of dissolving or eroding off upon sufficient exposure to the fluid, thereby releasing the acid.

In addition, chelated materials can be used to provide a delay mechanism for the slow release of the acid in the treatment fluid. The treatment fluid can also comprise an oxidizer, such as the oxidizer disclosed in U.S. Pat. No. 6,737,385, or a delayed release oxidizer.

The treatment fluid can also include other conventional additives depending on the application of the treatment fluid. Example additives include, but are not limited to, proppants, gravel, solids suspending agents, pH adjusting, control agents, gel breakers, gel stabilizers, clay stabilizers, bactericides, surfactants, weighting agents such as hematite, barite or calcium carbonate, and the like, which do not adversely react with other components in the composition. The selection of such additives is within the ability of one skilled in the art, and depends on the particular application of the treatment fluid, such as fracturing fluid and gravel pack fluid applications.

The invention also includes a method for treating a subterranean formation penetrated by a wellbore, the method comprising the steps of: pumping a treatment fluid comprising: (i) an aqueous carrier fluid; (ii) a zeolite; (iii) a polymeric gelling material; and (iv) a delayed release acid; and introducing the treatment fluid into the wellbore.

As mentioned, the step of introducing the treatment fluid into the formation through the wellbore can further comprise introducing the treatment fluid under sufficient conditions to produce a filter cake. The step of introducing the treatment fluid into the formation through the wellbore can also comprise introducing the treatment fluid under sufficient conditions to produce an external filter cake on the formation with minimal penetration of the filter cake into the formation.

The filter cake that can be formed by the treatment fluid of the invention can be removed either by an internal breaker that is introduced into the subterranean formation along with the treatment fluid (such as delayed release acid) and, additionally, a clean up wash or external breaker can be subsequently introduced to the treatment fluid. For example, the clean up wash can be introduced through the wellbore to further break down the filter cake, which might have already been at least partially broken down by an internal breaker. In either case, the treatment fluid of the invention provides a fluid loss agent that is better able to be removed once it has formed filter cake.

Alternatively, the treatment fluid comprising an aqueous carrier fluid, a zeolite, and a polymeric gelling material can be introduced into the subterranean formation without a delayed release acid. In this embodiment of the invention, an external breaker can be introduced into the subterranean formation subsequent to the introduction of the treatment fluid.

In one embodiment, the invention provides a method for treating a subterranean formation penetrated by a wellbore, the method comprising the steps of: (a) pumping a treatment fluid comprising an aqueous carrier fluid; a zeolite; a polymeric gelling material; and (b) introducing the treatment fluid into the wellbore. The method can further comprise the step of introducing a breaker after the treatment fluid is introduced into the wellbore.

### EXAMPLE

Turning now to the FIGURE, illustrated is a graph plot of a comparison between the fluid loss solid Baracarb (calcite) and the fluid loss solid zeolite. All systems were made from starch (0.5%) and xanthan (0.5%). Two of the systems contained starch, xanthan, and one of two inorganic solids, zeolite or calcite. In the third control system, no inorganic solid was used in the system of starch and xanthan.

The xanthan is available from Kelco Inc. as their food grade material. The zeolite is available from INEOS Inc. as a detergent grade material of the pore size 4 A (granular size of 4 microns). Calcite of a mean particle diameter of 6 microns was used. The suspension was filtered at 22 Celsius through a Whatman 42 filter paper at 1000 psi, in a standard High Pressure High Temperature (HPHT) fluid loss cell.

As shown by the FIGURE, it is clear that addition of both zeolite and Baracarb fluid loss control additives are able to significantly reduce the amount of fluid loss in the porous rock. Thus, zeolite is comparable in effectiveness to Baracarb as a fluid loss agent.

Not only is zeolite comparable to Baracarb in its effectiveness to reduce fluid loss, zeolite is preferred because it requires less acid to dissolve than Baracarb, as shown by the Table below. Zeolite was advantageously dissolved by less acid of hydrogen chloride (0.93 Normality (N)) as well as less lactic acid, as illustrated in the Table below.

TABLE
Quantity of HCl or lactic acid required to
dissolve 1 gram (g) of Baracarb and Zeolite

| | Quantity of acid required to | Quantity of acid required to |
|---|---|---|
| Acid | dissolve 1 g of Baracarb. | dissolve 1 g of Zeolite. |
| 0.93 N HCl | 22.0 milliliters | 14.1 milliliters |
| Lactic acid | 1.8 g | 1.2 g |

Because zeolite requires less acid (about ⅔) to degrade than Baracarb, clean up of the filter cake formed of zeolite in a subterranean formation is easier with zeolite than with Baracarb.

After careful consideration of the specific and exemplary embodiments of the invention described herein, a person of ordinary skill in the art will appreciate that certain modifications, substitutions and other changes can be made without substantially deviating from the principles of the invention. The detailed description is illustrative, the spirit and scope of the invention being limited only by the appended Claims.

What is claimed is:

1. A treatment fluid for treating a subterranean formation penetrated by a wellbore, the treatment fluid comprising:
a) an aqueous carrier fluid;
b) a zeolite;
c) a polymeric gelling material; and
d) a delayed release acid.

2. The treatment fluid according to claim 1, wherein the zeolite is selected from the group consisting of an acid soluble zeolite.

3. The treatment fluid according to claim 1, wherein the zeolite is selected from the group consisting of synthetic zeolites.

4. The treatment fluid according to claim 1, wherein the zeolite has a pore size of about 4 Angstroms.

5. The treatment fluid according to claim 1, wherein the polymeric gelling material comprises a polymer and a crosslinker.

6. The treatment fluid according to claim 1, wherein the delayed release acid comprises poly(lactic acid).

7. The treatment fluid according to claim 1, further comprising xanthan.

8. The treatment fluid according to claim 1, further comprising proppant.

9. The treatment fluid according to claim 1, further comprising gravel.

10. A method for treating a subterranean formation penetrated by a wellbore, the method comprising the steps of:
a. pumping a treatment fluid comprising:
a) an aqueous carrier fluid;
b) a zeolite;
c) a polymeric gelling material; and
d) a delayed release acid; and
b. introducing the treatment fluid into the wellbore.

11. The method according to claim 10, wherein the zeolite is selected from the group consisting of an acid soluble zeolite.

12. The method according to claim 10, wherein the zeolite is selected from the group consisting of synthetic zeolites.

13. The method according to claim 10, wherein the zeolite has a pore size of about 4 Angstroms.

14. The method according to claim 10, wherein the polymeric gelling material comprises a polymer and a crosslinker.

15. The method according to claim 10, wherein the delayed release acid comprises poly(lactic acid).

16. The method according to claim 10, wherein the step of introducing the treatment fluid into the formation through the wellbore further comprises introducing the treatment fluid under sufficient conditions to produce a filter cake.

17. The method according to claim 10, wherein the step of introducing the treatment fluid into the formation through the wellbore further comprises introducing the treatment fluid under sufficient conditions to produce an external filter cake on the formation with minimal penetration of the filter cake into the formation.

18. The method according to claim 10, further comprising the step of subsequently introducing an acid into the wellbore.

19. A method for treating a subterranean formation penetrated by a wellbore, the method comprising the steps of:
a. pumping a treatment fluid comprising:
a) an aqueous carrier fluid;
b) a zeolite;
c) a polymeric gelling material; and
b. introducing the treatment fluid into the wellbore.

20. The method according to claim 19, further comprising the step of introducing a breaker after the treatment fluid is introduced into the wellbore.
